(19) United States
(12) Patent Application Publication
(10) Pub. No.: US 2008/0286728 A1
(43) Pub. Date: Nov. 20, 2008

(54) Methodology of Accounting Teaching

(75) Inventor: Arfah Salleh, Kuala Lumpur (MY)

Correspondence Address: LOWE HAUPTMAN HAM & BERNER, LLP, 1700 DIAGONAL ROAD, SUITE 300, ALEXANDRIA, VA, 22314, US

(73) Assignee: Computer-Based Learning SDN BHD, Kuala Lumpur (MY)

(21) Appl. No.: 11/996,766

(22) PCT Filed: Feb. 20, 2006
(86) PCT No.: PCT/SG06/00034

§ 371 Date: May 28, 2008

(30) Foreign Application Priority Data
Jul. 28, 2005 (MY) PI 20053470

(51) Int. Cl. G09B 19/18

(52) U.S. Cl. 434/109

(57) ABSTRACT

An accounting teaching methodology using a simulation module is disclosed in which processes are included to generate journals, ledgers and financial statements. Various inputs are allowed throughout the processes for students to perform entries at various stages. The simulation module is invented to complement traditional teaching and learning of accounting, enabling teaching and learning in an effective manner so that at the end students are able to understand accounting concepts and accounting cycles and to construct by themselves the relevant financial statements in addition to displaying said financial statements automatically. Students should also be able to perform all the processes involved leading to the financial statements after being properly taught or trained by using the invention.

### CROSS-REFERENCE TO RELATED APPLICATIONS

The present Application is based on International Application No. PCT/SG2006/000034, filed on Feb. 20, 2006, which in turn corresponds to Malaysian Patent Application No. PI20053470 filed on Jul. 28, 2005, and priority is hereby claimed under 35 USC §119 based on these applications. Each of these applications are hereby incorporated by reference in their entirety into the present application.

### FIELD OF THE INVENTION

The present invention pertains to accounting teaching methodology. More particularly, the invention relates to a novel teaching methodology using simulation module that guides students, step by step, to generate financial statements starting from journal entries, requiring various input throughout whole process.

### BACKGROUND OF THE INVENTION

Effective accounting teaching methodology is vital for learning the whole accounting procedures. Various accounting teaching methods have been disclosed. However, all of these methods are limited to teaching of the accounting concepts in a manual accounting system, targeted to establish the concepts of double entry accounting, without disclosing the methodology of preparing full set of account, such as disclosed in Europe patent No. WO2005004090 and U.S. Pat. No. 4,142,305. On a computerized platform, on the other hand, commercial accounting software packages require users to understand the accounting concepts prior to preparation of full set of account. In addition, such packages are programmed to be as efficient as possible, automating much of the journal entries or ledger posting. This makes them unsuitable for teaching accounting concepts and accounting documents preparation.

### SUMMARY OF THE INVENTION

The simulation module of the present invention takes a new approach to accounting teaching methodology based on computerized platform. It guides students to learn through the whole accounting cycle step-by-step beginning from journal entries until the final financial statements display. Furthermore, students are allowed to enter at least one input throughout the cycle. At the end of the process, students are expected to be able to understand the relevant concepts, such as single and double entries accounting, and procedures, such as ledger posting, in order to prepare a full set of accounting records and related financial statements for at least one accounting cycle based on a computerized platform. The invented teaching methodology reinforces the learning process by the use of a simulation module together with learning modules, both of which may be part of a computerized courseware.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a flowchart showing the entire simulation module for teaching journal entries until financial statements generation.

FIG. 2 is a part of FIG. 1 showing detail in the simulation for teaching preparation of general journal, general ledgers and subsidiary ledgers subsequent to journal entries.

FIG. 3 is a part of FIG. 1 showing in detail the simulation for teaching preparation of trial balance subsequent to preparation of ledgers.

FIG. 4 is a part of FIG. 1 showing in detail the simulation for teaching manual preparation of financial statements.

FIG. 5 is a part of FIG. 1 showing in detail the automatic preparation of financial statements.

FIG. 6 is part of FIG. 1 showing in detail the simulation for teaching setting up and entries in general and special journals.

### DETAILED DESCRIPTION OF THE DRAWINGS

The following detailed description describes the invention as illustrated in the figures briefly described above. Numberings used in through out the detail description are consistent for similar steps or elements of the invention. The detailed description merely exemplifies preferable modes of practice for the invention and is shall by no means construed to be limiting the scope of the invention.

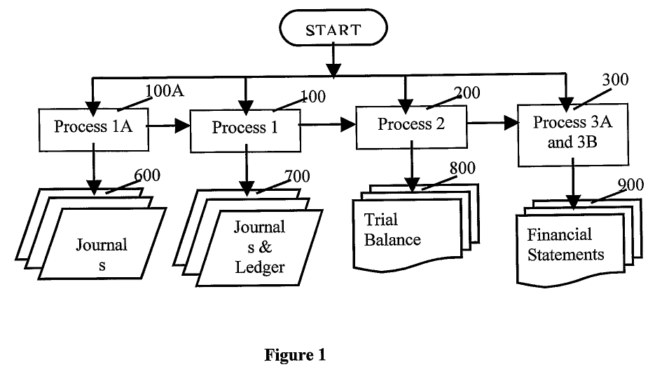

FIG. 1 shows a flowchart which illustrates every embodiments of the invention. Students are guided throughout the simulation module from Process 1A (100A) to generation of financial statements (900). In one embodiment of the invention, Process 1A is not included yet but journals and ledgers (700), which include general journal, general ledger and subsidiary ledger, are established in Process 1 (100). Preparation of accounts then proceeds to Process 2 (200) after which trial balance (800) is produced. Finally, financial statements (900) are generated through Process 3 (300). In a second preferred embodiment of the invention, students are allowed to do ledger posting by retrieving the database created in Process 1A (100A) and proceed to Process 1 (100) without doing the data entries (101). The breaking up of the entire invention into different designated processes is not limiting in any way but merely a matter of convenience to aid the description of the invention.

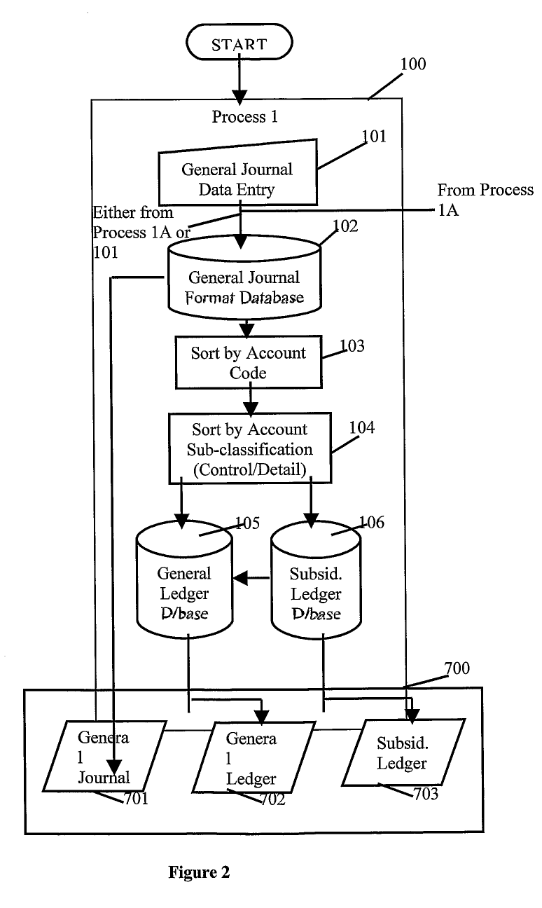

Referring now to FIG. 2, the establishment of general journal (701) and ledgers, namely general ledger (702) and subsidiary ledger (703), will be discussed. The students need to prepare the chart of accounts prior to General Journal entries. In another embodiment of the invention, the students can also select predetermined accounts from a given list.

After that the first input to be performed by a student is entries in General Journal (101). A general journal entry includes name of accounts involved and transaction amount involved. Each account involved is debited and credited by the student during each said inputting general journal entry. All transactions will be analyzed by the student in this step (101) according to the classification of accounts set and are recorded in the general journal. Preferably, accounts are classified according to their transaction. Also, students are trained to differentiate the recording of debit and credit, called double entry accounting, which deemed to have two aspects or two effects. The journal entries (101) are then stored in General Journal Format Database (102) after which General Journal (701) is displayed based on the student's entries. In the stage of charting the account, students are required to assign identification code to each account. Preferably, analysis of how each account should be positioned in the relevant financial statement is carried out prior to said code assignment. Assume that, for example, in the Current Asset category, there are four accounts listed: Cash, Bank, Inventory and Debtors. If Cash is to be listed first, followed by Bank, Debtors and Inventory in the Current asset category of the balance sheet, then Cash account should be assigned a code that has the smallest value, followed in sequence by Bank, Debtors and Inventory. Sorting of accounts is performed in step (103) based on student's input.

Students are also required to provide additional information such as details of Account Type (either Control, Details or Subsidiary), details of Parent Account (name of parent account if relevant) or details of Account Sub-classification (either Cash, Bank, Discount or Others) in the chart of accounts. Based on students' input, the computer will further sort the accounts according to the account types in step (104). The parent accounts (control accounts) can have either detail or subsidiary accounts as child. In the financial statements which preparation will be further explained later, control accounts with its subsidiary accounts are reflected by only displaying the control account with its totals amount (being the sum of the balances of all said subsidiary accounts). On the other hand, the control account names will be displayed in the financial statement as headings without the total amount and the respective child accounts will be displayed with each individual amount under the respective headings.

As for the Sub-classification, the information is required for the preparation of Cash Book. For this purpose, only Cash, Bank and Discount (both Sales and Purchase Discounts) are affected. The accounts need to be categorized into Cash, Bank or Discount category. For all other accounts, they are classified into the “Others” category.

Next, General Ledger Database (105), which includes parent or control accounts, and Subsidiary Ledger Database (106), which includes child accounts, are displayed after posting from journal by the computer. Said General Ledger Database (105) includes a collection of accounts and the related account codes whereas said Subsidiary Ledger Database (106) includes all the relevant ledgers defined by students which can be accumulated and put into the General Ledger Database (105) again. Then, General Ledger data (702) and Subsidiary data (703) are displayed from said General Ledger Database (105) and said Subsidiary Ledger Database (106), respectively. The General Ledger (702) specifically lists accounts for assets, liabilities, owners' equity, income and expenses whereas the Subsidiary Ledger (703) is a detail account book having a controlling account in said General Ledger (702).

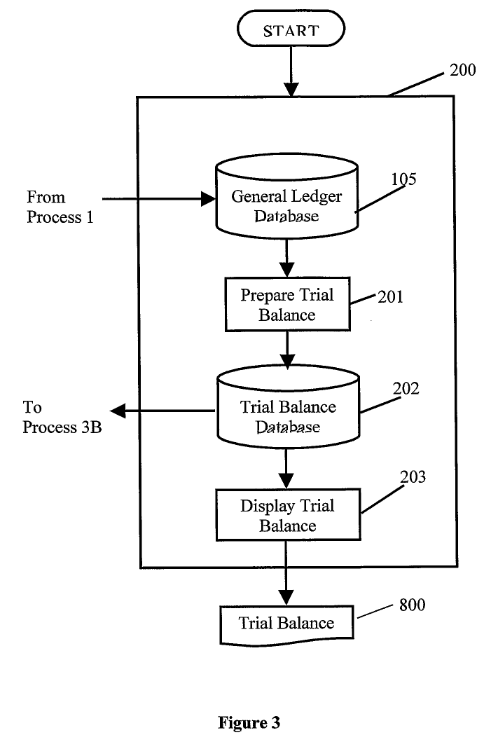

With reference now to FIG. 3, the General Ledger Database (105) can be taken from Process 1 (100) to start the generation of trial balance (800) as outlined throughout the flowchart in Process 2 (200). First, the simulation program prepares the Trial Balance (201) by retrieving the data from the database (105). Next, the database of said trial balance is stored in Trial Balance Database (202) after which the software allows students to provide a second input that is by setting the accounting period for the purpose of measuring the performance of an entity. The trial balance (800) is then displayed (203) where the student will know whether all the postings for the accounting period done in the general journal (101) were proper. Total debits posted will be equal to the total credits posted in the Trial Balance (800) only when the chart of accounts are properly set and general journal entries (101) are properly carried out. Previously omitted transactions, if any, are added in and adjusting entries for accrued and deferred items, if any, are journalized and posted again to T-account in said ledger.

The value of learning lies in allowing the students to realize that they had made mistakes during general journal entries (101). The simulation program allows the student to back track to general journal posting (101) and do corrections by posting omission or adjustment entries. At the juncture of Trial Balance (203), students may need to go back to step (101) to do omission or adjustment entries for more than once until the Trial Balance (800) balances. This is because the computer cannot generate the proper financial statements (900B) even if the students choose to go on to Process 3. It is also preferable that the student would not be able to go on to financial statements preparation if the trial balance is not correct.

It is to be noted that trial balances may not balance for at least two reasons. Firstly, the ledgers are not correctly done which includes doing the arithmetic wrongly, applying the book-keeping rules wrongly, omission of journal entries or ledger postings, carelessness in transferring ledger entries to trial balance sheet. Secondly, the rules of carrying out the Trial Balances are wrongly executed. Learning accounting or specifically book-keeping has been difficult for majority of the students because both types of error may be committed in a single exercise by a student. A mixture of these errors all the more confuses the student who is still new to accounting or book-keeping.

With the present invention, trial balance based on ledger database that is filled by the student's postings is always carried out correctly according to book-keeping rules. Therefore, the only source of errors in the Trial Balance could only come from the first reason of errors. It is obvious to a person in the art now that by the use of the invention, students can improve their book-keeping by getting to redo their wrongly entered journals or wrongly posted ledgers. Previously, such method of teaching book-keeping is not obvious because the task of preparing trial balance for each every students in a typical classroom setting is daunting. Therefore, the invention is preferably executed on a computerized platform.

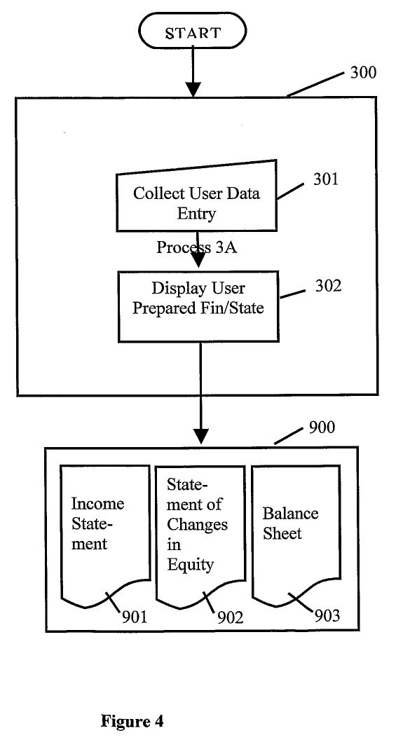

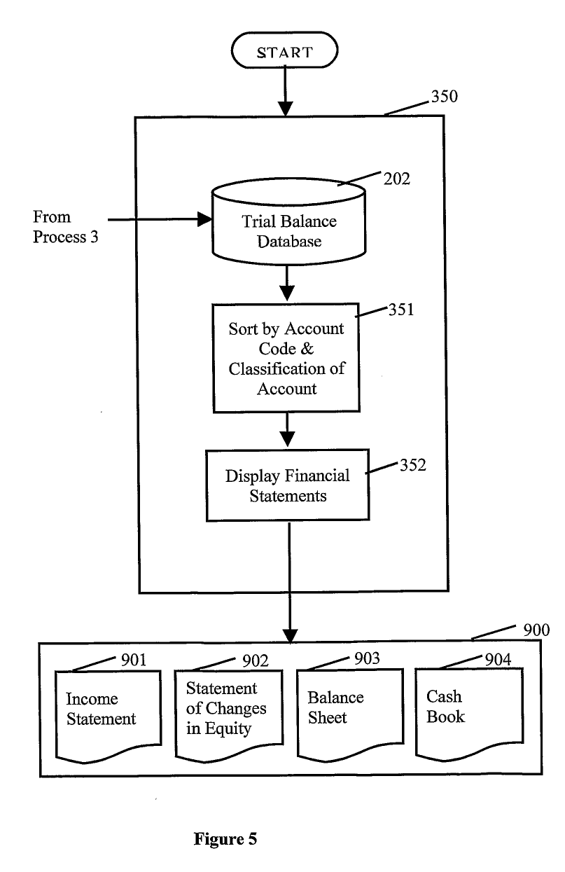

It is during repetition of checking the Trial Balance (800) result and reposting the general journal entries that the students can reinforce their double entries concept and general journal entries skills. Furthermore through such repetition, the students will become more and more adept with different accounts in accounting because they will be strongly grounded to recognize which account should have debit or credit balances respectively. With enough practice, students can see the overall picture of all the accounts related to a given entity, as they will also understand how one account affects the other related accounts. They will also understand how all transactions will affect the overall financial condition of that given entity. The simulation module then leads to two processes that run concurrently, namely Process 3A (300) in FIG. 4, which is performed manually by students, and Process 3B (350) in FIG. 5, which is performed automatically by computer. User Data Entry is collected (301) in Process 3A (300) in the current embodiment of the invention. In this step (301), students are required to choose the financial period, to format the financial statements and to decide what accounts should be entered into which financial statement. The computer then displays the financial statements (302) based on earlier input, including Income Statement (901), Statement of Changes in Equity (902) and Balance Sheet (903) prepared by students.

In the Process 3B (350), on the other hand, the financial statements (900) are prepared by the computer automatically. Retrieving data from the trial balance database (202) from Process 2 (200), the embodiment of the invention allows students to choose the financial period to be displayed at this stage. The accounts are then classified into five main categories, namely assets, liabilities, owner's equity, revenues and expenses during sorting and classifying of accounts by account codes (451). This is followed by displaying Financial Statements (352) after which computer generated financial statements (900B) including Income Statement (901B), Statement of Changes in Equity (902B), Balance Sheet (903B) and Cash Book (904) are displayed. The value of learning lies in allowing the students to compare correctly prepared financial statements (900B) with those prepared manually in Process 3A. Note that the automatic process allows the Cash Book (904) to be displayed in the invention.

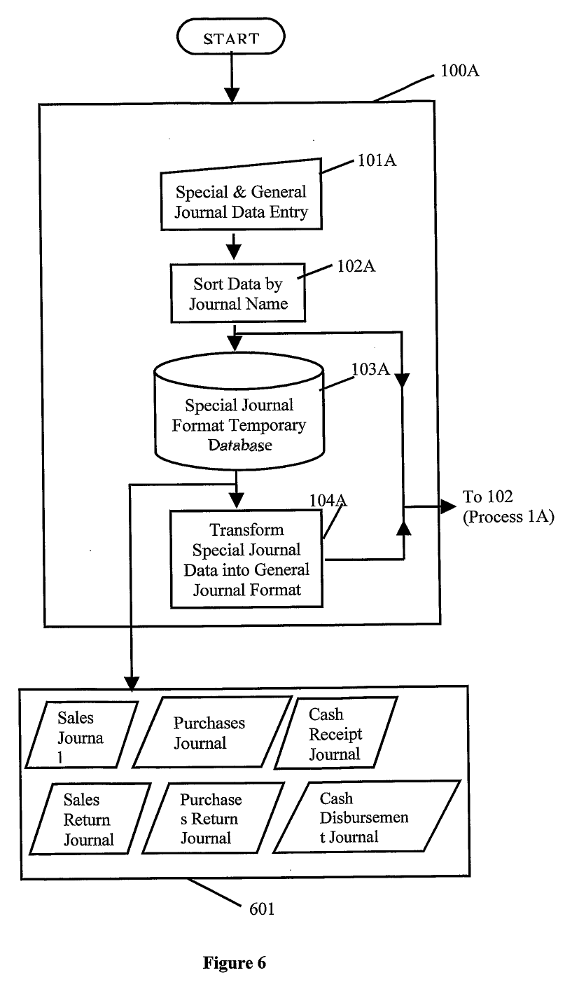

In second embodiment of the invention, additional steps are introduced prior to Process 1 (101) so that the invention takes on a new flow (100A) as represented in FIG. 6. Referring now to FIG. 6 in detail, the additional steps allow students to enter special journal entries (101A) in additional to the general journal data entry. It is to be noted that in the first embodiment of the invention comprising Process 1, 2, 3A and 3B, only general journal entries (101) can be accepted in FIG. 2. Furthermore when process 1A is inserted prior to Process 1 to form the second embodiment of the invention, General Journal entries (101) in Process 1 as shown in FIG. 1 will no longer be carried out in Process 1 but are carried out as a step of entering Special and General Journal entries (101A) in Process 1A as shown in FIG. 6.

Special journal entries involve single entry accounting while general journal data entry trains students to do double entry accounting. When students are using the simulation module, all given transactions are journalized according to respective source documents and are recorded in the appropriate special journals and general journal (101A). At this juncture, students identify which transaction should be recorded in the respective journals, categorize special journal according to respective accounts and appropriately credit and debit respective accounts that are related to the General Journal.

The process then proceeds to step (102A), where data in corresponding journals are sorted according to journal name by the simulation module, after which all the special journals are stored in a Special Journal Format Temporary Database (103A). The computer then displays said special journals (600), including but not limited to, sales journal, purchases journal, cash receipt journal, sales return journal, purchases return journal and cash disbursement journal. By including the steps described in Process 1A as shown in FIG. 6, the second embodiment of the invention will also allow students to practice on all journals used in accounting.

In the second embodiment of the invention, the general journal format is also stored in the General Journal Format Database (102) after which the data is sorted by the simulation program according to the journal names in step (102A) as explained earlier. In this embodiment, the database (102) further includes special journal entries that are transformed into a format that can be merged with existing general journal entries. The transformation is accomplished by through step (104A), details of which are being described in another copending Malaysian Patent Application Number PI2005______ that is filed by the same inventor and incorporated herein by reference in its entirety. Following this, general journal (701) is displayed. It is to be noted that now general journal (701) also include special journals entries, which could not be incorporated in the absence of Process 1A.

Referring back now to the FIG. 2, the General Journal Format Database (102) in Process 1 (100) can be retrieved directly from Process 1A (100A) by omitting the general journal data entry step (101) as explained earlier. In still another embodiment of the invention, students can be required to do ledger posting for accounts that are related to the various special journals. This will test the students' ability to appropriately credit and debit respective accounts that are related to various Special Journals. These ledger postings should appropriately take place after Special Journal entries are completed (101A) but before sorting of accounts (101) according to account codes takes place, such at the juncture where 101 is.

Alternatively, students can also be requested to perform ledger posting manually unlike the first embodiment where general ledger posting was done automatically by the simulation module based on students' general journal entries. Through these manual general ledger postings, students' understanding and skills related general ledger postings could be reinforced further.

Referring back now to the FIG. 3, where the trial balance (800) is displayed by computer and is checked thoroughly by students for any errors. In the first embodiment of the invention (where Process 1A (100A) is absent), it allows the students to go back to general journal data entry (101) in FIG. 2 and perform the adjustment entries or omission entries when the accounts are unbalanced. In the second embodiment of the invention (where Process 1A (100A) is present), it allows the students to go back and perform error correction in both general and special journal entries (101A). Students will also do adjustment entries or omission entries, and perform ledger postings again in Process 1 (100) in FIG. 2.

In a further embodiment of the invention, features to prompt the students on any mistake done in journal entries prior to displaying trial balance (203) is also contemplated. This feature is possible because it is a possible extension of the Temporary Database (103A) and the transformation process (104A) in Process 1A. Addition of this new feature in the invented simulation module can also reinforce the learning of accounting.

Besides the two most preferred embodiments of the invention, other embodiments of the invention are also possible by requesting different inputs from students at different stages and displaying to the students the results of their entries at different stages. Different inputs are requested from the students in order to train or test them on different aspects of accounting. These require different modules to be included which may be module to teach preparation of source documents, module to train students to classify each given account according to account types or according to transaction and module to compare and check the student prepared financial statements against the computer generated financial statements. Additional modules such as these may be added to the invention but will not depart from the scope of the invention.

Another possible embodiment of the invention is to omit journal entry from the process but requiring students to do ledger postings directly based on source documents. It is also apparent to a person with ordinary skill in the art that a computer readable recording medium can store the instructions to execute the present method of teaching accounting. Once the teaching methodology is presented, it is deemed that the person reasonably skilled in the art can encode the instructions to carry out the teaching methodology. The methodology to teach accounting can then be carried out by executing the instructions recorded on the computer readable recording medium on a computer and by having a student being taught or trained with the methodology executed on the computer. Furthermore, the computer readable program can also store the necessary learning module for student's reference as they are learning accounting by the new methodology.

A modified version of the instructions can also allow each student to learn accounting by the methodology through individual computers which are part of a network of computers. The modified instructions will be executed on a server which is also part of the same network. Local area network (LAN) is will be used for a classroom environment in a school while wide area network (WAN) such as Internet is suitable for distant learning programs. Communication protocols would need to be added to the modified instructions to carry out the teaching methodology through a network of computers. Other necessary software and hardware modules would included as necessary to carry out the teaching methodology through a network of computers.

The modifications to the various aspects of the present invention described herein above are merely exemplary. It is understood that other modifications to the illustrative embodiments will readily occur to persons with ordinary skill in the art without departing from the scope and spirit of the present invention as defined by the accompanying claims.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1-39. (canceled)

40. A tutorial system for teaching accounting including an accounting module comprising the steps of:
a) requiring a user to input journal entries, the inputting journal entries includes providing name of accounts and inserting transaction amount into the accounts by debit and credit;
b) generating journal based on the inputted journal entries;
c) requiring the user to assign an account code to each account;
d) sorting the accounts according to the assigned account code for charting the accounts;
e) requiring the user to assign account type to each account;
f) sorting the accounts according to the assigned account type;
g) posting the journal entries into ledger sheets and generating the ledger sheets;
h) requiring the user to select financial period;
i) generating trial balance based on the ledger sheets in accordance to the financial period;
j) commanding the user to rectify the inputted journal entries and the account code assignment when the trial balance is not balanced;
k) classifying the accounts of the financial period according to the account codes, the classifying of the accounts is based on the trial balance;
l) generating financial statements in accordance to the steps (j) to (k);
m) requiring the user to select the accounts of the selected financial period into corresponding user financial statements and format the user financial statements; and
n) displaying user financial statements.

41. The tutorial system according to claim 40, wherein the journal in step (b) refers to general journal.

42. The tutorial system according to claim 40 further comprising the step of requiring the user to assign an account sub-classification to each account.

43. The tutorial system according to claim 40 further comprising the step of sorting the accounts according to the assigned account sub-classification.

44. The tutorial system according to claim 41 further comprising the step of displaying the generated general journal to the user.

45. The tutorial system according to claim 40, wherein the ledger sheets in step (g) and (i) includes general ledger and ledger.

46. The tutorial system according to claim 45 further comprising the step of displaying the generated general ledger and the generated ledger to the user.

47. The tutorial system according to claim 40 further comprising the step of requiring the user to post the journal entries into the user ledger sheets.

48. The tutorial system according to claim 47 further comprising the step of displaying the user general ledger and the user ledger.

49. The tutorial system according to claim 47 further comprising the step of commanding the user to rectify the posting of the journal entries into the ledger sheets when the user general ledger and ledger are not tallied to the generated general ledger and ledger.

50. The tutorial system according to the claim 40, wherein the step (a) further comprises inputting special journal entries whereby the inputting special journal entries includes transaction being recoded in respective special journals and categorizing the special journals according to respective accounts whereby the accounts are appropriately debited and credited.

51. The tutorial system according to the claim 50 further comprising the step of sorting the special journals according to the respective name and generating special journals based on the inputted special journal entries.

52. The tutorial system according to the claim 51 further comprising the step of displaying the special journals to the user.

53. The tutorial system according to the claim 51 further comprising the step of transforming the special journal entries in a format to be merged with the general journal entries.

54. The tutorial system according to the claim 53, wherein the step (b) further comprising the step of generating a general journal based on the general journal entries and the special journal entries.

55. The tutorial system according to the claim 50 further comprising the step of commanding the user to rectify the inputted special journal entries when the trial balance is not balanced.

56. The tutorial system according to claim 55 further comprising the step of requiring the user to post the special journal entries into the user ledger sheets.

57. The tutorial system according to claim 56 further comprising the step of commanding the user to rectify the posting of the special journal entries into the ledger sheets when the user general ledger and ledger are not tallied to the generated general ledger and ledger.

58. The tutorial system according to claim 40, wherein the step (m), the formatting of the financial statements includes requiring the user to decide the accounts to be included into the respective financial statement.

59. The tutorial system according to claim 40 further comprising the step of commanding the user to correctly select the accounts of the selected financial period into corresponding user financial statements and correctly format the user financial statements when the user financial statements are not tallied to the generated financial statements.

60. The tutorial system according to claim 59, wherein the accounting module is installed into a computer readable recording medium whereby instructions are stored.

61. The tutorial system according to claim 60, wherein the accounting module is installed in a network of computers whereby the steps in the accounting module are executed and accessed by the computer selectively.
